(19) United States
(12) Patent Application Publication
(10) Pub. No.: US 2014/0276289 A1
(43) Pub. Date: Sep. 18, 2014

(54) Deep Vein Thrombosis Prevention Garment

(71) Applicant: Compression Therapy Concepts, Inc., Eatontown, NJ (US)

(72) Inventors: Orlando Mansur, JR., Eatontown, NJ (US); Leonard Nass, Eatontown, NJ (US)

(21) Appl. No.: 14/216,030

(22) Filed: Mar. 17, 2014

Related U.S. Application Data
(60) Provisional application No. 61/786,424, filed on Mar. 15, 2013.

(51) Int. Cl. A61H 9/00; A61H 1/00

(52) U.S. Cl. CPC A61H 9/0078; A61H 1/008
USPC 601/152; 601/151

(57) ABSTRACT

A deep vein thrombosis prevention garment includes a central panel formed to have three (3) sequentially filled air chambers separated from each other with a pressure resistive valve, a left side panel, and a right side panel formed with a number of attachment straps having an integral fastener. The first air chamber receives air from a pump. When the air within the first air chamber reaches a predetermined air pressure, the pressure resistive valve between the first air chamber and the second air chamber allows air to pass from the first air chamber to a second air chamber. When the air within the second air chamber reaches a predetermined air pressure, the pressure resistive valve between the second air chamber and the third air chamber allows air to pass from the second chamber to the third air chamber. A membrane panel allows air to escape the sequentially filled air chambers.

### RELATED APPLICATION

This application claims the benefit of priority to U.S. Provisional Application No. 61/786,424, filed on Mar. 15, 2013, entitled “Deep Vein Thrombosis Prevention Garment”, and currently co-pending.

### FIELD OF THE INVENTION

The present invention relates generally to medical and therapy devices. The present invention is more particularly useful as a compression garment for use in the prevention of deep vein thrombosis. The present invention is particularly useful to prevent deep vein thrombosis during periods of low or no activity by continually circulating blood through a patient's extremities.

### BACKGROUND OF THE INVENTION

Deep Vein Thrombosis, or “DVT”, is a blood clot (“thrombus”) that forms in a vein deep in the body. A thrombus occurs when blood thickens and clumps together. Most of these thrombi occur in the lower leg or thigh; however, they can also occur in other parts of the body. Thrombi located in the thigh are more likely to break off and cause a pulmonary embolism (“PE”) than clots in the lower leg or other parts of the body. The clots that form close to the skin usually cannot break off and cause a PE due to their reduced size and the reduced pressures exerted on them.

A DVT, or a portion of it, can break off and travel through the bloodstream where it can enter the lung and block blood flow. This condition is called pulmonary embolism, which is considered to be very serious due to its likelihood of causing damage to the lungs and other organs and quite possibly leading to death. This condition affects more than 2.5 million Americans each year and is associated with an estimated 50.000 to 20,0000 deaths annually.

The venous system is designed to allow for the return of blood to the right side of the heart. Veins are not passive tubes through which blood passes, but are a system that uses muscular compressions, gravity, and inter-venous valves to promote and control the flow of blood through them. The valves are located along the entire length of the vein and ensure that blood only flows in one (1) direction, toward the heart. Blood flow may easily pass through the valve in the direction toward the heart, but when pressure is greater above the valve than below, the cusps will come together, thereby closing the valve and stopping the further flow of blood to the heart.

The valves consist of two (2) very thin-walled cusps that originate at opposite sides of the vein wall and come together to meet at the midline of the vein. The diameter of the vein is slightly larger just behind the valve where the cusps attach to the vein wall. Due to the larger diameter of the vein and the propensity for blood to collect and stagnate between the valve cusps and the vein wall, thrombi formation in this area is more likely.

The most common causes of DVT are venous stasis, blood vessel wall injury, and hypercoagulability. Venous stasis is the reduction of blood flow, most notably in the areas of venous valves, usually caused by extended periods of inactivity. These periods of inactivity minimize the muscular compressions applied to the veins, and remove the forces used to propel the blood through the veins, accordingly. This reduction in flow allows the blood to collect and congeal, thereby forming a clot. The conditions that contribute to venous stasis include heart disease, obesity, dehydration, pregnancy, a debilitated or bed-ridden state, stroke, and surgery. Stasis has been known to develop with surgical procedures lasting as lithe as 30 minutes.

Vessel wall injury can disrupt the lining of the vein, thereby removing the natural protections against clotting. The loss of natural protection will increase the chances of clot formation and the subsequent mobilization of the dot that can lead to a PE. Some of the major causes of vessel wall injury are trauma from fractures and burns, infection, punctures of the vein, injection of irritant solutions, susceptibility to DVT, and major surgeries.

Hypercoagulability exists when coagulation outpaces fibrinolysis, which is the body's natural mechanism to inhibit dot formation. When this condition exists, the chances of dot formation, especially in areas of low blood flow, are greatly increased. Some causes of hypercoagulability are trauma, surgery, malignancy, and systemic infection. A typical treatment is the administration of an anti-coagulant such as of low-molecular-weight heparin.

It is recognized that dots usually develop first in the calf veins and “grow” in the direction of flow in the vein. The dots usually form behind valve pockets where blood flow is lowest. Once a dot forms, it either enlarges until it is enveloped, which causes the coagulation process to stop, or the dot may develop a “tail” which has a high chance of breaking off and becoming mobile where it can enter the pulmonary system and become lodged in the lungs.

In a patient with DVT, the goals are to minimize the risk of a PE, limit further dots, and facilitate the resolution of existing dots. If a potential dot is suspected or detected, bed rest is usually recommended to allow for the dot to stabilize and adhere to the vein wall, thereby minimizing the chance of the dot becoming mobile such that it can travel to the lungs. A more effective preventative measure is ambulation, which is to walk about or move from place to place. Ambulation requires muscle movement. The muscle movement will provide a continuous series of compressions to the veins, thereby facilitating the flow of blood. The continuous flow of blood will reduce or eliminate any areas of stasis so dots do not have a chance to form. For people who are confined to a bed or will be immobile for an extended period of time, leg elevation is recommended. This will promote blood return to the heart and will decrease any existing venous congestion.

Graduated compression stockings have also been used to apply pressure to the veins so as to reduce or minimize any areas of low flow in the vein, while not allowing the collection and coagulation of blood in these low flow areas. The stockings are designed to provide the highest level of compression to the ankle and calf area, with gradually decreasing pressure continuing up the leg. The stockings prevent DVT by augmenting the velocity of venous return from the legs, thereby reducing venous stasis. Typically, stockings are applied before surgery and are worn until the patient is fully able to move on their own. The stockings need to fit properly and be applied correctly. If too tight, they may exert a tourniquet effect, thereby promoting venous stasis, the very problem trying to be prevented. If too loose, the stockings will not provide adequate compression.

Another treatment of DVT involves the use of intermittent pneumatic compression (IPC). IPC can be of benefit to patients deemed to be at risk of deep vein thrombosis during extended periods of inactivity and is an accepted treatment method for preventing blood clots or complications of venous stasis in persons after physical trauma, orthopedic surgery, neurosurgery, or in disabled persons who are unable to walk or mobilize effectively.

An IPC uses an air pump to inflate and deflate airtight sleeves wrapped around the leg. The successive inflation and deflations simulate the series of compressions applied to the veins from muscle contractions, thereby limiting any stasis that can lead to thrombi formation. This technique is also used to stop blood clots from developing during surgeries that will last for an extended period of time. Another version of IPC is the Venous Foot Pump which provides an alternative to the traditional thigh or calf compression device. The foot pump mimics the natural effects of walking and weight-bearing on the circulation in the feet and legs through compressions applied to the foot. PE remains the most common preventable cause of death in hospitalized patients. The deaths are most often a complication resulting from the formation of a DVT and the subsequent PE that may result from it.

In light of the above, it would be advantageous to provide a deep vein thrombosis prevention garment that minimizes the occurrence of deep vein thrombosis formation. It would be further advantageous to provide a deep vein thrombosis prevention garment that allows medical personnel to customize the compression of limbs being treated to optimize treatments for particular patients. It is a further advantage to provide a deep vein thrombosis prevention garment that provides a sequential inflation of pressure-producing chambers with a single air input. It would also be advantageous to provide a deep vein thrombosis prevention garment that is easy to use, relatively easy to manufacture, and comparatively cost efficient.

### SUMMARY OF THE INVENTION

The deep vein thrombosis prevention garment of the present invention includes a central panel, a left side panel, and a right side panel formed with a number of attachment straps having an integral fastener, such as Velcro brand hook and loop fasteners. The central panel is formed to have three (3) sequentially filled air chambers separated from each other with a pressure resistive valve. The first air filled chamber receives air from a pump through a flexible air supply tube.

When the air within the first air filled chamber reaches a predetermined air pressure, the pressure resistive valve between the first air filled chamber and the second air filled chamber allows air to pass from the first air filled chamber to a second air filled chamber. Likewise, when the air within the second air filled chamber reaches a predetermined air pressure, the pressure resistive valve between the second air filled chamber and the third air filled chamber allows air to pass from the second air filled chamber to the third air filled chamber.

In the event that the air pressures within the first, second or third air filled chamber exceeds a predetermined maximum, a membrane panel formed in the third air filled chamber allows air to escape the sequentially filled air chambers. The membrane can have a threshold pressure, and which prevents air from passing through the membrane until that threshold pressure is exceeded.

The deep vein thrombosis prevention garment of the present invention is worn by a patient on an extremity that is subject to development of thrombosis, particularly deep vein thrombosis, and particularly during surgery or extended periods of inactivity. In use, the deep vein thrombosis prevention garment may be wrapped snugly around a patient's leg, then once activated, the pump provides a periodic air supply to the garment through the flexible air supply tube leading to the first air filled chamber.

As the first air filled chamber becomes partially inflated, the first air filled chamber fills with air to provide pressure on the leg of the patient to urge blood flow upward through the leg. As this air pressure is maintained through the flexible air supply tube, the first air filled chamber becomes pressurized to a predetermined pressure, such as 35 mmHg, and air begins to pass through the pressure resistant valve to the second air filled chamber. As the second air filled chamber inflates, it provides additional pressure on the leg of the patient to urge blood flow further upward through the leg. As the air pressure is continued through the flexible air supply tube, the first air filled chamber and second air filled chamber become pressured to a predetermined pressure, and air begins to pass through the pressure resistant valve to the third air filled chamber. As the third air filled chamber inflates, it provides additional pressure on the leg of the patient to urge blood flow even further upward through the leg.

The sequential inflation of the first air filled chamber, second air filled chamber and third air filled chamber creates a peristaltic force on the veins within the limb being treated. Once all three (3) air filled chambers are pressurized to a predetermined pressure, the pressurized air supplied to the flexible air supply tube is discontinued, and all three (3) air filled chambers deflate, returning the deep vein thrombosis prevention garment of the present invention to its fully un-inflated configuration. In this fully un-inflated configuration, blood flows freely through the limb being treated.

The inflation and deflation timing cycle of the deep vein thrombosis prevention garment of the present invention is determined by the pressures being utilized, and the speed by which the air filled chambers deflate. In order to effectively urge blood flow through deep veins, the timing for the peristaltic effect of the deep vein thrombosis prevention garment of the present invention is approximately twenty (20) seconds per cycle.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a top plan view of the deep vein thrombosis prevention garment of the present invention showing a central panel, a left side panel, and a right side panel formed with a number of attachment straps having an integral fastener, and with the central panel having three (3) sequentially filled air chambers (shown in dashed lines) receiving air from a pump through a flexible air supply tube;

FIG. 2 is a view of the deep vein thrombosis prevention garment of the present invention being used by a patient for the prevention of deep vein thrombosis, showing a pump supplying pressurized air through a flexible air supply tube;

FIG. 3 is a top plan view of the deep vein thrombosis prevention garment of the present invention with portions out away for clarity, showing the internal three (3) sequentially filled air chambers which are interconnected with a pressure resistive valve that requires a minimum pressure to build up within a first air filled chamber before allowing air to pass into the subsequent air filled chamber, and a membrane panel for releasing any over-pressure;

FIG. 4 is a side cross-sectional view of the deep vein thrombosis prevention garment of the present invention as taken along line 4-4 of FIG. 3, showing the relative positions of the three (3) sequential air filled chambers when the deep vein thrombosis prevention garment is in the un-inflated configuration, and the positioning of the pressure resistive valves between each air filled chamber such that when a predetermined minimum pressure builds up within a first air filled chamber, the pressure resistive valve will allow air to pass into the subsequent air filled chamber until each chamber is filled;

FIG. 5 is a side cross-sectional view of the deep vein thrombosis prevention garment of the present invention as taken along line 4-4 of FIG. 3, showing the relative positions of the three (3) sequential air filled chambers when the deep vein thrombosis prevention garment is in the inflated configuration, and directional arrows depicting typical airflow from the flexible air supply tube to the first air filled chamber through the pressure resistive valve to the second air filled chamber, through the pressure resistive valve to the third air filled chamber;

FIGS. 6-9 depict the deep vein thrombosis prevention garment of the present invention as used on the leg of a patient starting with an un-inflated configuration, and advancing through the inflation of each sequential air filled chamber;

FIG. 6 is an exemplary partial cross-sectional view of the deep vein thrombosis prevention garment of the present invention as used on the leg of the patient, showing the deep vein thrombosis prevention garment in a deflated configuration in which lithe or no pressure is exerted on the leg of the patient and blood flows unrestrictedly through the leg;

FIG. 7 is an exemplary partial cross-sectional view of the deep vein thrombosis prevention garment of the present invention as used on the leg of the patient, showing the deep vein thrombosis prevention garment in a partially inflated configuration with the first air filled chamber filled with air to provide pressure on the leg of the patient to urge blood flow upward through the leg;

FIG. 8 is an exemplary partial cross-sectional view of the deep vein thrombosis prevention garment of the present invention as used on the leg of the patient, showing the deep vein thrombosis prevention garment in a partially inflated configuration with the first air filled chamber filled with air to provide pressure on the leg and pass through the first pressure resistive valve to fill the second air filled chamber to provide additional pressure on the leg of the patient to urge blood flow further upward through the leg;

FIG. 9 is an exemplary partial cross-sectional view of the deep vein thrombosis prevention garment of the present invention as used on the leg of the patient, showing the deep vein thrombosis prevention garment in a fully inflated configuration with the first air filled chamber filled with air to provide pressure on the leg and pass through the first pressure resistive valve to fill the second air filled chamber, and the second air filled chamber filled with air to provide additional pressure on the leg and pass through the second pressure resistive valve to fill the third air filled chamber to provide yet additional pressure on the leg of the patient to urge blood flow further upward through the leg;

FIG. 10 is a graphical representation of the air pressure supplied from the pump to the deep vein thrombosis prevention garment of the present invention, showing a maximum air pressure to be delivered, and the sequential pressure within each of the air filled chambers during a sequential inflation cycle before pressure supplied from the pump is released and all air filled chambers deflate;

FIG. 11 is a top plan view of the pressure resistive valve of the deep vein thrombosis prevention garment of the present invention, showing the chamber wall with the pressure resistive valve having a base which includes a pressure sensitive valve that is surrounded by a circular spacer formed with gaps in order to make sure that air can pass from air filled chamber to air filled chamber without the exit of the pressure resistive valve becoming blocked;

FIG. 12 is a side view of the pressure resistive valve of the deep vein thrombosis prevention garment of the present invention, showing the chamber wall with the pressure resistive valve having a base which includes a pressure sensitive valve that is surrounded by a circular spacer formed with gaps in order to make sure that air can pass from air filled chamber to air filled chamber without the exit of the pressure resistive valve becoming blocked, and a typical air flow through the pressure resistive valve when a minimum desired pressure differential across the valve exists;

FIG. 13 is an alternative embodiment of the deep vein thrombosis prevention garment of the present invention showing a three-chamber garment having a supply hose that leads to a first chamber, a bleed valve that allows air to pass from the first chamber to a second chamber, and a bleed valve that allows air to pass from the second chamber to a third chamber, with the third chamber having an over-pressure membrane that provides for protection against over-pressurization;

FIG. 14 is a cross-sectional view of the deep vein thrombosis prevention garment of the present invention taken along line 14-14 of FIG. 13, showing the three (3) distinct inflation chambers with a bleed valve that extends between the first and the second, and the second and third chambers to facilitate the controlled passage of air from the first chamber, through the second chamber, and to the third chamber;

FIG. 15 is an end view of the bleed valve of the deep vein thrombosis prevention garment of the present invention, showing a circular valve formed with a circular bore longitudinally through the center of the valve to restrict air flow therethrough;

FIG. 16 is a cross-sectional view of the bleed valve of the deep vein thrombosis prevention garment of the present invention, showing the length of the body for the valve along with the central bore;

FIG. 17 is another alternative embodiment of the deep vein thrombosis prevention garment of the present invention, showing a three-chamber garment having each connected via an inter-chamber flow tube that provides for the passage of air from the first chamber, through the inter-chamber flow tube to the second chamber and the third chamber; and

FIG. 18 is a cross-sectional view of the alternative embodiment of the deep vein thrombosis prevention garment of the present invention taken along lines 18-18 of FIG. 17, showing the inter-chamber flow tube that facilitates the flow of air from the first chamber to the second and third chambers.

### DETAILED DESCRIPTION OF A PREFERRED EMBODIMENT

Referring initially to FIG. 1, FIG. 1 is a top plan view of the deep vein thrombosis prevention garment of the present invention generally designated 100. Garment 100 includes a central panel 102, a left side panel 104, and a right side panel 106. Garment panels 102, 104, and 106 are flexible and formed with an inside layer 105, an outside layer 103, and a perimeter binding 107 stitching the inside layer 105 and the outside layer 103 together. In a preferred embodiment, the inside layer 105 of the deep vein thrombosis prevention garment are made from durable cloth or other non-woven material that can comfortably contact a patient's skin.

A flexible air supply tube 108 enters central panel 102 and leads to a series of sequentially filled air chambers 110, 112, and 114 (shown in dashed lines). This flexible air supply tube 108 is shown having a non-descript length. It is to be appreciated that the length of the tube 108 may vary depending on the particular field of use and the setting. For instance, in a hospital surgery selling, it may be difficult to position an air source immediately adjacent to the patient, and an extended air supply tube 108 is required.

Air is supplied to the flexible air supply tube 108 from a pump 140. In a preferred embodiment, pump 140 includes a compressor capable of providing a predetermined maximum air pressure force to fill the sequentially filled air chambers 110, 112, and 114. As will be described in greater detail below, pump 140 connected to the flexible aft supply tube 108 can provide air at a predetermined pressure for a predetermined period of time, providing for an inflation and deflation cycle according to the desired therapy parameters.

As shown in FIG. 1, right side panel 106 is formed with a number of attachment straps 124, 126, and 128, with each strap having an integral fastener 130, 132, and 134, respectively. In a preferred embodiment, straps 124, 126, and 128 are provided with a hook-and-loop style fasteners 130, 132, and 134. These hook-and-loop fasteners cooperate with the outside layer 103 of panels 102 and 104 to allow the deep vein thrombosis prevention garment 100 of the present invention to be positioned about a patient's limb and secured in place by wrapping the panels 102, 104 and 106 around the limb and firmly pressing the fasteners 130, 132, and 134 on straps 124, 126, and 128 against the outside layer 103. The hook-and-loop fasteners attach to the outside layer 103 to hold the straps 124, 126, and 128 in place. This type of fastener and method of attachment of the deep vein thrombosis prevention garment 100 provide a deep vein thrombosis prevention garment for patients having limbs of different sizes and can accommodate large or small diameter limbs simply by wrapping the panels 102, 104 and 106 around the limb and securing straps 124, 128, and 128 in place.

While the deep vein thrombosis prevention garment of the present invention in a preferred embodiment is manufactured having a hook-and-loop type fastener 130, 132, and 134, it is to be appreciated that any other types of fastener known in the art may be used without departing from the present invention.

Referring now to FIG. 2, the deep vein thrombosis prevention garment 100 of the present invention being used by a patient 50 for the prevention of deep vein thrombosis is shown. Specifically, as shown, the deep vein thrombosis prevention garment 100 is positioned around the lower leg 52, or calf, of patient 50, in communication with pump 140 through flexible air supply tube 108. Pump 140 supplies pressurized air through flexible air supply tube 108 to pressurize the sequentially filled air chambers 110, 112, and 114 (shown in FIG. 1).

FIG. 2 depicts a patient in a sitting position and this shows merely an exemplary use of the deep vein thrombosis prevention garment 100 of the present invention. Indeed, the deep vein thrombosis prevention garment of the present it may be used with patients virtually in any position. As will be described in greater detail below, the inflation and deflation cycle of the sequentially filled air chambers 110, 112, and 114 may vary depending on the particular patient, and the particular environment. For instance, a patient using the deep vein thrombosis prevention garment of the present invention in a sitting position may opt for a faster inflation and deflation cycle, and may utilize higher air pressures in the sequentially filled air chambers 110, 112, 114 than a patient using the deep vein thrombosis prevention garment in a supine position on an operating table.

It is also to be appreciated that while FIG. 2 depicts a patient 50 having one deep vein thrombosis prevention garment on a leg, a number of deep vein thrombosis prevention garments may be used simultaneously. For instance, in a surgery setting, it is commonplace to utilize the deep vein thrombosis prevention garment of the present invention on both legs.

As shown in FIG. 2, the deep vein thrombosis prevention garment 100 is positioned around the calf 52 of a patient 50 by positioning panels 102 and 104 (shown in FIG. 1) against the patient's leg, wrapping straps 124, 126, and 128 around the calf 52, and then securing the straps to the outside layer 103 (shown in FIG. 1) of panel 104 with fasteners 130, 132, and 134 (shown in FIG. 1).

Referring now to FIG. 3, a top plan view of the deep vein thrombosis prevention garment 100 of the present invention is shown with portions of the outside layer 103 (shown in FIG. 1) of the central panel 102 cut away for clarity. The internal three (3) sequentially filled air chambers 110, 112, and 114 are easily shown from this view.

First air filled chamber 110 receives a pressurized of source through the flexible air supply tube 108 and fills with air, thereby expanding the first air filled chamber 110. As the air pressure reaches a predetermined minimum level, a pressure resistive valve 116 allows air from the first air filled chamber 110 to pass through the pressure resistive valve 116 into the second air filled chamber 112. As air continues to be provided into the first air filled chamber 110, through the flexible air supply tube 108, the pressure remains in excess of the predetermined minimum level for pressure resistive valve 116, and thus air continues to flow into the second air filled chamber 112 that is equipped with a second pressure resistive valve 118 leading from the second air filled chamber 112 to the third air filled chamber 114. When the second air filled chamber 112 becomes pressurized in excess of a predetermined minimum level, pressure resistive valve 118 allows of from the second air filled chamber 112 to pass into the third air filled chamber 114, through the pressure resistive valve 118.

As sequentially filled air chambers 110, 112, and 114 are continued to be provided with pressurized air from the flexible air supply tube 108 and pump 140, the pressure in each chamber will continue to rise until the chamber pressures equalize with the pressure of the air from pump 140. In a preferred embodiment of the deep vein thrombosis prevention garment of the present invention, the third air filled chamber 114 may be provided with a membrane panel 120 for releasing any over-pressure. Specifically, membrane panel 120 is a non-woven material that provides resistance to the flow of air through the membrane. When the pressure within the third air filled chamber 114 exceeds a maximum value, air passes through membrane 120 to release the excess pressure, thereby preventing excessive air pressure within the sequentially filled air chambers 110, 112, and 114.

In a preferred embodiment, the pressure resistive valves 116 and 118 are designed to remain closed until the pressure within the first air filled chamber reaches a predetermined minimum. In a preferred embodiment, the predetermined minimum may be the same for valve 116 and 118, or it may be different. For instance, in a preferred embodiment, the predetermined minimum for pressure resistive valve 116 may be 35 mmHg, and the predetermined minimum for pressure resistive valve 118 may be 25 mmHg.

As shown in FIG. 3, the sequentially filled air chambers 110, 112, and 114 are formed from a durable plastic sheeting 121 that is flexible and durable, and capable of withstanding prolonged periods of inflation and deflation without damage. In a preferred embodiment, the dual sheeting 121 is made of polyvinyl chloride (PVC), but other materials known in the art may also be used.

One benefit of using sheeting 121 is the ability to create seals, such as seals 122, to form the individual sequentially filled air chambers 110, 112, and 114. These seals may be made by sonic welding, heat sealing, or any other methods known in the art. It is important to note that the sequentially filled air chambers 110, 112 and 114 are formed using two (2) layers of sheeting 121 (as will be shown in greater detail below in conjunction with FIGS. 4 and 5). Each of the seals 122 provides for an air-tight seal between the two (2) layers of sheeting 121 and allows for the pressurization of the resulting chambers.

While the deep vein thrombosis prevention garment 100 of the present invention is shown to be configured with three (3) sequentially filled air chambers 110, 112, and 114, it is to be appreciated that the deep vein thrombosis prevention garment of the present invention may be equipped with additional number of sequentially filled air chambers. These additional sequentially filled air chambers function like the current sequentially filled air chambers 110, 112, and 114, and would fill in sequence.

Referring now to FIG. 4, a side cross-sectional view of the deep vein thrombosis prevention garment 100 of the present invention, taken along line 4-4 of FIG. 3, is shown. From this cross-sectional view, the relative positions of the three (3) sequential air filled chambers 110, 112, and 114, when the deep vein thrombosis prevention garment is in the un-inflated configuration, are shown. Specifically, from this view, it can be easily seen that each sequentially filled air chamber extends into the adjacent air chamber to accommodate placement of the pressure resistive valves. For instance, the first air filled chamber 110 is formed with an upward portion extending into the second air filled chamber 112 such that the pressure resistive valve 116 lies substantially flat and parallel with panel 102, yet provides an air passageway from the first air filled chamber 110 to the second air filled chamber 112. Similarly, the second air filled chamber 112 is formed with an upward portion extending into the third air filled chamber 114 such that the pressure resistive valve 118 lies substantially flat and parallel with panel 102, yet provides an air passageway from the second air filled chamber 112 to the third air filled chamber 114.

As shown in FIG. 4, the deep vein thrombosis prevention garment 100, when in its deflated configuration, is substantially flat allowing a secure placement of the device on the limb 52 (shown in FIG. 2) of a patient 50 (shown in FIG. 2). In the deflated configuration, the panels 102 and 104 (shown in FIGS. 1 and 3) are snugly wrapped around the limb 52 (shown in FIG. 2), and the straps 124, 126 and 128 (shown in FIGS. 1, 2, and 3) are secured to the outside of panel 104 (shown in FIGS. 1 and 3).

The dual sheeting 121 is shown in FIG. 4. Specifically, the first layer of the dual sheeting 121 is adjacent to the second layer of the dual sheeting 121 and formed with seals, such as seal 122 (shown in FIG. 3), to create the sequentially filled air chambers 110, 112, and 114. These seals 122 are flexible and provide for the expansion of each sequentially filled air chamber 110, 112 and 114 as they inflate. Further, the positioning of the pressure resistive valves 116 and 118 between each sequentially filled air chamber 110, 112, and 114, allow the air to pass into the subsequent air filled chamber even though the deep vein thrombosis prevention garment 100 is substantially fiat when positioned on a patient 50 (shown in FIG. 2).

Referring to FIG. 5, another side cross-sectional view of the deep vein thrombosis prevention garment 100 of the present invention, taken along line 4-4 of FIG. 3, is shown. FIG. 5 depicts the deep vein thrombosis prevention garment 100 in a fully inflated configuration. For clarity, FIG. 5 includes a number of directional arrows depicting typical airflow from the flexible air supply tube 108 to the first air filled chamber 110, through the pressure resistive valve 116 to the second air filled chamber 112, through the pressure resistive valve 118 to the third air filled chamber 114.

The expandability of the sequentially filled air chambers 110, 112 and 114 is also easily appreciated in FIG. 5. As shown in FIG. 5, the first air filled chamber 110 includes an upper portion 123 that is folded and includes the pressure resistive valve 116. Upper portion 123, due to the fold, allows for the two (2) layers of the dual sheeting 121 to separate freely when the sequentially filled air chambers 110, 112 and 114 are inflated and provides no binding between the dual sheeting 121.

Referring now to FIGS. 6 through 9, exemplary views of the deep vein thrombosis prevention garment 100 of the present invention, as used on the leg 52 of a patient 50 (shown in FIG. 2), starting with an un-Inflated configuration in FIG. 6, and advancing through the inflation of each sequentially filled air chamber in FIG. 9, are depicted.

Starting with FIG. 6, an exemplary partial cross-sectional view of the deep vein thrombosis prevention garment 100 of the present invention in a deflated configuration, as used on the leg 52 of the patient, is depicted. In the deflated configuration, little or no pressure is exerted on the leg 52 of the patient and blood flows through the leg without restriction. As depicted in FIG. 7, as air is introduced into the flexible air supply tube 108 (shown in FIGS. 1-5) and begins to fill the first air filled chamber 110, air pressure is introduced to the leg 52 to urge blood within the leg flow upward in direction 150.

As air is continually introduced into the first air filled chamber 110, a predetermined minimum pressure is reached in the first air filled chamber 110. Then the pressure resistive valve 116 allows the air to flow from the first air filled chamber 110 to the second air filled chamber 112. As the second air filled chamber 112 inflates, it provides additional pressure on the leg 52 of the patient to urge blood flow further upward through the leg in direction 152, as shown in FIG. 8.

As air is continually introduced into the first air filled chamber 110, the air flows from the first air filled chamber 110 into the second air filled chamber 112. When a minimum pressure is reached in the second air filled chamber 112, the pressure resistive valve 118 allows the air to flow from the second air filled chamber 112 to the third air filled chamber 114, as shown in FIG. 9. As the third air filled chamber 114 inflates, it also provides additional pressure on the leg 52 of the patient to urge blood flow further upward through the leg in direction 154.

When a single inflation cycle is completed, the air pump 140 (shown in FIGS. 1-2) releases the air pressure to the flexible air supply tube 108, and the air dissipates through the flexible air supply tube 108 and through the pressure membrane 120 (shown in FIG. 3), to return the deep vein thrombosis prevention garment 100 of the present invention to its originally deflated state, as shown in FIG. 6. This cycle is repeated according to a particular patient profile, and may be repeated for extended periods of time, in order to minimize the likelihood that thrombosis will develop in the patient.

Referring now to FIG. 10, a graphical representation of the air pressure supplied from the pump to the deep vein thrombosis prevention garment of the present invention is shown and generally referred to as 200. Graph 200 includes a vertical Air Pressure axis 202 and a horizontal Time axis 204. This graph 200 depicts a typical inflation and deflation cycle that occurs in the deep vein thrombosis prevention garment of the present invention.

Graph 200 includes a primary supply air pressure curve 206 which corresponds to the air provided by pump 140 (shown in FIGS. 1-2) to flexible air supply tube 108 (shown in FIGS. 1-5). This air supply begins at the start of the inflation cycle and rises to a maximum supplied air pressure 208. This maximum supplied air pressure 208 is approximately equal to an overall maximum pressure 220 (shown by dashed one) that corresponds to the maximum desired pressure within the sequentially filled air chambers 110, 112, and 114 (shown in FIGS. 1, and 3-5), the maximum pressure medically safe, or any other maximum value utilized in the art to ensure safe operation of the deep vein thrombosis prevention garment of the present invention.

As the pressure within the flexible air supply tube 108 (shown in FIGS. 1-5) is supplied to the first air filled chamber 110, the pressure 210 within the first air filled chamber 110 begins to increase. As the first air filled chamber 110 begins to reach its maximum capacity, the pressure within the chamber passes the minimum pressure (depicted as value 224), to activate the pressure resistive valve 116 (shown in FIGS. 3-5). At that time 212, the air begins to pass through the pressure resistive valve 116 into the second air filled chamber 112.

The maximum air pressure 208 is maintained and as the air continues to pass into first air filled chamber 110, through the pressure resistive valve 116 and into the second aft filled chamber 112, the air pressure 214 in the second air filled chamber 112 rises. As the second air filled chamber 112 begins to reach its maximum capacity, the pressure within the second air filled chamber 112 passes the minimum pressure (again depicted as value 224), to activate the pressure resistive valve 118 (shown in FIGS. 3-5). At that time 216, the air begins to pass through the pressure resistive valve 118 into the third air filled chamber 114.

The inflation cycle is completed once the three (3) sequentially filled air chambers 110, 112, and 114 have had sufficient time to inflate. Following the inflation cycle, the deflation cycle begins at time 218 and the pressure 222 in the flexible air supply tube 108 decreases to zero. It is also contemplated that along with the decrease in the pressure 222 of the flexible air supply tube 108, the pressures 210, 214 and 217 likewise return to zero in substantially the same time. Once this inflation and deflation cycle is completed, a delay may be inserted prior to beginning of the next inflation and deflation cycle.

Using the deep vein thrombosis prevention garment 100 of the present invention, the time for a complete inflation cycle, deflation cycle and delay is approximately twenty (20) seconds. As a result, the deep vein thrombosis prevention garment 100 can be cycled three (3) times every minute in order to provide a continuous force to create the desired peristaltic effect. It is to be appreciated that the specific period for a complete cycle may be changed depending on the size of the limb being treated, the pressure desired, and the peristaltic forces necessary to minimize the likelihood of the development of a thrombosis.

The pressure 224 depicted in FIG. 10 has been shown the same for both pressure resistive valve 116 and pressure resistive valves 118. However, it is to be appreciated that the pressure resistive valves may be different, and utilize different minimum air pressures. Indeed, in a preferred embodiment, pressure resistive valve 116 may have a minimum air pressure of 35 mmHg, while pressure resistive valve 118 may have a minimum air pressure of 25 mmHg. Other pressures may be utilized without departing from the present invention.

Referring now to FIG. 11, a top plan view of an exemplary pressure resistive valve 116 of the deep vein thrombosis prevention garment 100 of the present invention is shown. This valve 116 is shown attached to the chamber wall 121 with the pressure resistive valve 116 having a base 250 which includes a pressure resistive membrane 256 that is surrounded by a circular spacer 252 formed with gaps 254 in order to make sure that air can pass from one air filled chamber to the next air filled chamber without the pressure resistive membrane 256 becoming blocked.

As shown from side view FIG. 12, the pressure resistive valve 116 of the deep vein thrombosis prevention garment 100 of the present invention shows the chamber wall 121 with the pressure resistive valve 116 having a base 250 which includes a pressure resistive membrane 256 (shown in FIG. 11) that is surrounded by a circular spacer 252 formed with gaps 254 in order to make sure that air can pass through the pressure resistive valve 116 from a first air filled chamber in directions 260 and 262 to a second air filled chamber in directions 264 and 266. In the event that the adjacent sheeting 121 covers the exit of the pressure resistive valve 116, air will nevertheless pass through the gaps 254 when a minimum desired pressure differential across the valve exists.

### DESCRIPTION OF ALTERNATIVE EMBODIMENTS

Referring now to FIG. 13, an alternative embodiment of the deep vein thrombosis prevention garment of the present invention is shown and generally designated 300. The deep vein thrombosis prevention garment 300 of the present invention includes a three-chamber garment formed with weld 302 having a supply hose 304 that leads to an net 306 within a first air filled chamber 308. First air filled chamber 308 is formed between two (2) layers of flexible polymer and sealed along welds 310 and 318 so that air flowing from net 306 enters the first air filled chamber 308 to create a pressurized chamber. The pressurized air from the first air filled chamber 308 passes through a bleed valve 316 that allows air to pass from the first air filled chamber 308 to a second aft filled chamber 322. Specifically, the first air filled chamber 308 is formed between welds 310, 312 and 318 that create an expandable chamber such that when positioned against a limb of a user, the air flowing into the first aft filled chamber 308 creates pressure that expands the nested portion 320 of the first air filled chamber 308. As the air pressurizes the first air filled chamber 308, air begins to pass through bleed valve 316 and into the second air filled chamber 322.

Second air filled chamber 322 is formed between welds 310, 312, and 326 as air flows through bleed valve 316 and into the second air filled chamber 322, the pressure within chamber 322 begins to increase which results in nested portion 328 of the second air filled chamber 322 increasing to expand into the nested portion 328 of the second air filled chamber 322. As the pressure within the second air filled chamber 322 increases, air flows through bleed valve 324 and into the third air filled chamber 330. Third air filled chamber 330 is formed between welds 323, 302, and 310 and expands as air flows through bleed valve 324.

In an alternative embodiment, the deep vein thrombosis prevention garment 300 is formed with pressure membranes 340 and 342 in air filled chambers 322 and 330, respectively. Pressure membranes 340 and 342 provide for the passage of air when there is a pressure differential across the membrane. For instance, when there is a pressure differential between the interior of the second air filled chamber 322 and the ambient environment, air will pass through the pressure membrane 340. This feature provides a safety against the over-pressurization of the second air filled chamber 322 and ensures that the pressures that are exerted against a user of the deep vein thrombosis prevention garment 300 of the present invention are safe. In this alternative embodiment, the pressure membranes 340 and 342 provide for a maximum pressure differential of 30 mmHg, thereby ensuring that the user is not exposed to excessive pressures within the garment 300.

Referring now to FIG. 14, a cross-sectional view of the deep vein thrombosis prevention garment 300 of the present invention taken along line 14-14 of FIG. 13 is shown. From this view, the three (3) distinct inflation air filled chambers 308, 322 and 330 are shown with bleed valves 316 and 324 extending between the first and second, and the second and third air filled chambers to facilitate the controlled passage of air from the first air filled chamber 308, through the second air filled chamber 322, and to the third air filled chamber 330.

Also from this view, the expandability of the sequentially filled air chambers 308, 322 and 330 are clearly shown. Specifically, nested portions 320 and 328 (shown in FIG. 13) extend into adjacent chambers to provide for the expansion of the chamber as the air into the chambers increase in volume. As shown in FIG. 14, the welds 312 and 323 are welded at the ends only. As air passes through bleed valves 316 and 324, the nested portions extend to allow more air to be contained within the sequentially filled air chambers 308, 322 and 330, thereby providing a compressive effect against the limb of a user of the garment 300.

FIG. 15 is an end view of the bleed valve 324 of the deep vein thrombosis prevention garment 300 of the present invention showing a circular valve body 350 having an outer diameter 352 and formed with a circular bore 354 having an internal diameter 356. From this view, it is to be appreciated that the bleed valves 316 (shown in FIGS. 13-14) and 324 provide an air passageway through bore 354. It is also to be appreciated that the larger the diameter of bore 354, the larger air volume that is allowed to pass through the bleed valve 324 under any given air pressure. Consequently, the rate at which air passes from air filled chamber to air filled chamber in the deep vein thrombosis prevention garment 300 of the present invention may be adjusted by providing a bore diameter 354 that is larger for larger air flows, and smaller for smaller air flows. This allows for the adjustment of air flow through the deep vein thrombosis prevention garment 300 from the inlet 306 (shown in FIG. 13) through the first air filled chamber 308, to the second air filled chamber 322 to the third air filled chamber 330.

While it is shown in FIGS. 13 and 14 that the bleed valves 316 and 324 are shown to have the same internal bore diameters 356, it is fully contemplated that the bore diameter 356 may be different from bleed valve 316 and 324. Indeed, these bore diameters 356 can be selected to provide a specific and pre-determined inflation sequence between sequentially filled air chambers 308, 322 and 330.

Referring now to FIG. 16, a cross-sectional view of the bleed valve body 350 of the deep vein thrombosis prevention garment 300 of the present invention shows the length 358 of the valve body 350 and formed with a central bore 354 which extends longitudinally through the center of the valve 324 (shown in FIGS. 13-15) to restrict air flow therethrough. As shown, length 358 may be small such that the bleed valve 324 extends between the air filled chambers 308 to 322, and from 322 to 330. For instance, length 358 may be a fraction of an inch, and in this alternative embodiment, internal bore diameter 354 may be 0.0625 inches.

Referring now to FIG. 17, another alternative embodiment of the deep vein thrombosis prevention garment of the present invention is shown and generally designated 400. The deep vein thrombosis prevention garment 400 includes a three-chamber garment formed with weld 402. Specifically, a supply hose 404 leads an net 406 within a first air filled chamber 408 that is formed within welds 410, 412 and 418. As shown, aft enters the first air filled chamber 408 and passes into net 462 of inter-chamber flow tube 460 that provides for the passage of air from the first air filled chamber 408 to the second air filled chamber 422 and the third air filled chamber 430. From this view, it can be appreciated that the air from the first air filled chamber 408 passes through inlet 462 and through inter-chamber flow tube 460 in direction 464 to the second air filled chamber 422 defined by welds 410, 412 and 426. As the air flows in direction 466 through outlet 468 into the second air filled chamber 422, air also flows in direction 470 through outlet 472 into the third air filled chamber 430 defined by welds 410, 423 and 402. The alternative embodiment of the deep vein thrombosis prevention of the present invention is formed with pressure membranes 440 and 442 in air filled chambers 422 and 430, respectively. Pressure membranes 440 and 442 provide for the passage of air when there is a pressure differential across the membrane.

FIG. 18 is a cross-sectional view of the alternative embodiment of the deep vein thrombosis prevention garment 400 of the present invention taken along lines 18-18 of FIG. 17. This Figure shows the net 462 and outlets 468 and 472 of inter-chamber flow tube 460 that facilitates the flow of air from the first air filled chamber 408 to the second and third air filled chambers 422 and 430. From this view, it can be appreciated that the internal diameter of the inter-chamber flow tube outlets 468 and 472 control the flow of air from the first air filled chamber 408 to the second and third air filled chambers 422 and 430. While these internal diameters depicted in FIG. 18 to be substantially the same, it is to be appreciated that they may differ in order to provide a different flow rate from the first air filled chamber 408 to the second and third air filled chambers 422 and 430. Indeed, the flow rate of air through the inter-chamber flow tube 460 can be adjusted by providing different internal diameter.

In this alternative embodiment, the internal diameter of outlet 468 may be larger than the internal diameter of outlet 472 such that the air flowing into the second air filled chamber 422 is greater than the air flowing into the third air filled chamber 430, thereby ensuring that the chambers are inflated in order from the first chamber 408 to the second chamber 422 and the third chamber 430.

While there have been shown what are presently considered to be preferred embodiments of the present invention, it will be apparent to those skilled in the art that various changes and modifications can be made herein without departing from the scope and spirit of the invention.

1. A deep vein thrombosis prevention garment, comprising:
a central panel having a plurality of sequentially filled air chambers receiving air from a flexible air supply tube in communication with one or more said air chambers;
a left side panel extending from said central panel; and
a right side panel extending from said central panel opposite said left side panel and formed with one or more attachment straps having an integral fastener attachable to said left side panel.

2. The deep vein thrombosis prevention garment of claim 1, further comprising a pressure resistive valve positioned between each sequential air filled chamber and configured to pass air having a predetermined minimum pressure from a first air filled chamber to a second air filled chamber.

3. The deep vein thrombosis prevention garment of claim 2, further comprising said predetermined minimum pressure in the range of 25 mmHg to 35 mmHg.

4. The deep vein thrombosis prevention garment of claim 1, further comprising said predetermined minimum pressure being 25 mmHg.

5. The deep vein thrombosis prevention garment of claim 1, further comprising a pump in communication with said flexible air supply tube to provide air having a predetermined pressure sufficient to inflate one or more sequentially filled air chambers.

6. The deep vein thrombosis prevention garment of claim 5, wherein said predetermined pressure is 35 mmHg.

7. The deep vein thrombosis prevention garment of claim 5, further comprising said pump configured to provide air at the predetermined pressure for a fixed period of time.

8. The deep vein thrombosis prevention garment of claim 1, further comprising a means for releasing air from said sequentially filled air chambers if said air exceeds a pressure of 35 mmHg.

9. The deep vein thrombosis prevention garment of claim 1, further comprising a means for pressurizing said sequentially filled air chambers to 35 mmHg.

10. The deep vein thrombosis prevention garment of claim 2, wherein the pressure resistive valves have differing predetermined minimum pressures.

11. The deep vein thrombosis prevention garment of claim 1, further comprising a pressure membrane located between the sequentially filled air chambers and the ambient environment,
wherein the pressure membranes provide for the passage of air when there is a pressure differential across the membrane to prevent over pressurization of the air chambers.

12. The deep vein thrombosis prevention garment of claim 1, further comprising a bleed valve positioned between each sequential air filled chamber and configured to bleed air from a first air filled chamber to a second air filled chamber.

13. The deep vein thrombosis prevention garment of claim 12, wherein a first bleed valve has a different bore diameter, therefore a different bleed rate, than the bore diameter of a second bleed valve.

14. The deep vein thrombosis prevention garment of claim 13, wherein the bore diameters are selected to provide a pre-determined inflation sequence between sequentially filled air chambers.

15. The deep vein thrombosis prevention garment of claim 1, wherein the sequentially filled air chambers extend into adjacent chambers to provide for the expansion of the chamber as the air into the chambers increases in volume.

16. The deep vein thrombosis prevention garment of claim 1, further consisting of:
an inter-chamber flow tube with an inlet and a plurality of outlets; and
an air supply tube connected between an air source and the inlet;
wherein each sequentially filled air bag is connected to one of the outlets such that when air is supplied to the inter-chamber flow tube via the air supply tube, the sequentially filled air bags fill with air.

17. The deep vein thrombosis prevention garment of claim 16, wherein the air flow from the air source creates an inflation rate that is controlled by the internal diameter of each outlet such that the combination of inflation rates creates a peristaltic force on a limb.
